(19) United States
(12) Patent Application Publication
(10) Pub. No.: US 2005/0103540 A1
(43) Pub. Date: May 19, 2005

(54) Track with low friction reinforced guide blocks

(76) Inventor: Denys Lavoie, Sherbrooke (CA)

Correspondence Address: FULBRIGHT & JAWORSKI L.L.P., 600 CONGRESS AVE., SUITE 2400, AUSTIN, TX, 78701, US

(21) Appl. No.: 10/716,769

(22) Filed: Nov. 19, 2003

(51) Int. Cl. B62D 55/00

(52) U.S. Cl. 180/9.1

(57) ABSTRACT

The endless track of a track-propelled vehicle has an inner face provided with a series of longitudinally spaced guide blocks; the guide blocks have, on an opposite side faces thereof, pads made of low friction resin material to contact the mid rollers of the track assembly.

### FIELD OF THE INVENTION

The present invention pertains to an endless track for track-propelled vehicles wherein guide blocks formed on the inner surface of the track are provided with a reinforcing material.

### BACKGROUND OF THE INVENTION

Track-type vehicles have track assembly that normally includes an endless rubber belt which wraps around a drive wheel, an idler wheel and a number of rollers, called mid-rollers. The inner surface of the endless belt has a number of upstanding guide blocks which are guided through a channel formed between the wheel arrangement of the track assembly.

During use of the vehicle, the drive wheel rotates and engages the endless belt thereby causing the belt to rotate around the path defined by the drive wheel, idler wheel and mid-rollers. Rotation of the endless belt causes each of the guide blocks to pass through a channel defined by the drive wheel, idler wheel and each of the mid-rollers. Having the guide blocks passing through the guiding channel enables the belt to remain within the rolling path. The contact between the guide blocks passing next to the drive wheel, idler and each of the mid-rollers is a source of wear on these components. Friction between the guide blocks and the guiding wheels generates heat which accelerates deterioration of the guide blocks and the mid-rollers.

### STATEMENT OF THE INVENTION

It is an object of the present invention to provide a track wherein friction is minimized and heat generation is reduced between the mid rollers and the guide blocks by using a low friction material on the guide blocks.

It is a further object of the present invention to provide a low friction surface on at least a portion of the rubber guide block which contacts the wheel thus preventing the wheel from being removed from the track and to prevent the guide block from being worn or damaged by the wheel.

This is achieved by providing a resin of low friction properties to the member which is exposed to the contacting of the drive wheel, idler wheel and mid-rollers. During the belt molding process, a low friction material pad is embodied to the guide block opposite edges. By using a low friction material pad which has similar molding characteristics of rubber, at a given pressure and molding temperature, molecular reaction occurs between the low friction material pad and the rubber base compound. This provides the low friction material pads with adequate adhesion to properly stay in place, along the guide block edges, without any additional mechanical or bonding agent.

The present invention therefore relates to an endless track for track propelled vehicles having a track assembly including a drive wheel, an idler wheel and a series of rollers resting on a lower run of the track comprising: a body of elastomeric material having an inner surface and an outer surface; the inner surface displaying thereon a series of longitudinally spaced guide blocks; each guide block having a front face, a rear face and opposite side faces; the opposite faces being formed of pads made of low friction resin material.

Other objects and further scope of applicability of the present invention will become apparent from the detailed description given hereinafter. It should be understood, however, that this detailed description, while indicating preferred embodiments of the invention, is given by way of illustration only, since various changes and modifications within the spirit and scope of the invention will become apparent to those skilled in the art.

### BRIEF DESCRIPTION OF THE DRAWING

FIG. 1 is a perspective view showing part of an endless track with guide blocks made in accordance with the present invention;

FIG. 2 is a side view thereof; and

FIG. 3 is an end view thereof; and

FIG. 4 is a cross-sectional view taken along lines 4-4 of FIG. 2.

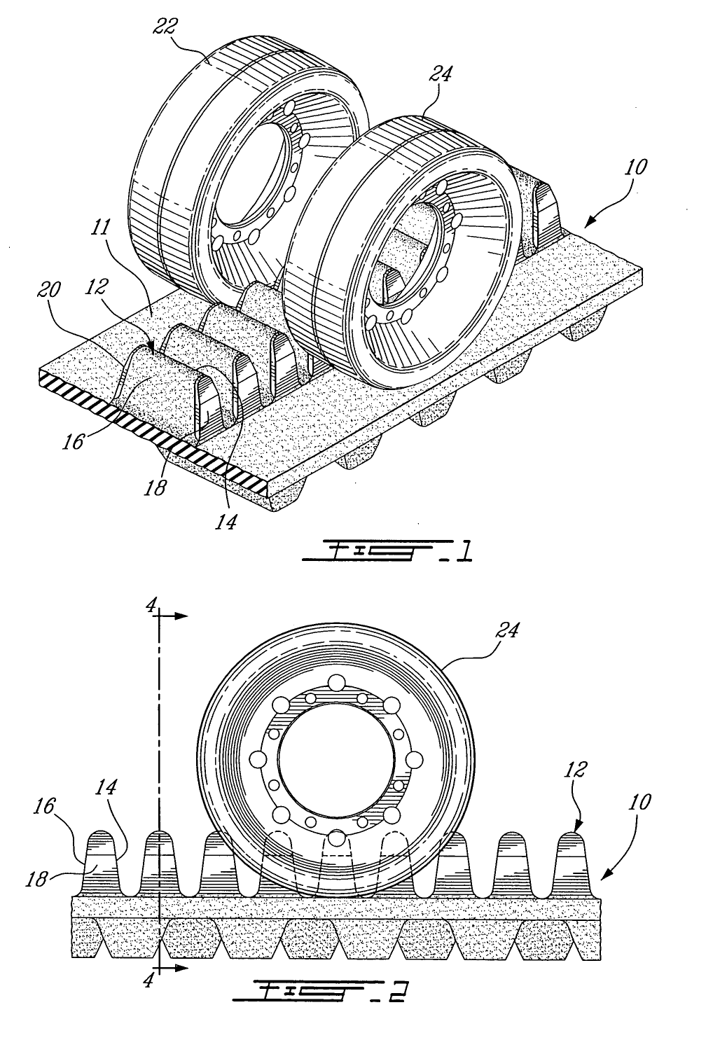

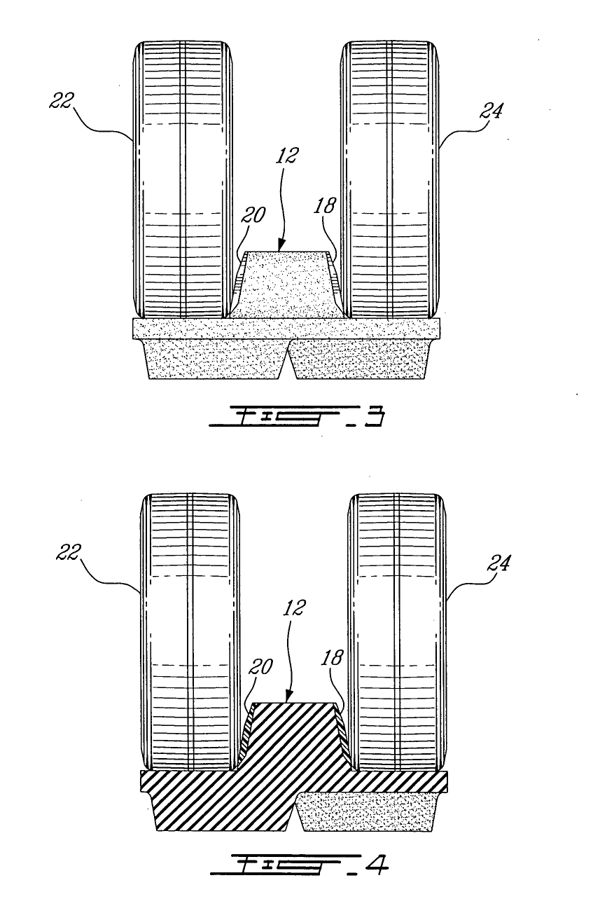

### DESCRIPTION OF PREFERRED EMBODIMENTS

Referring to the drawings, there is shown a segment 10 of an endless track having an inner face 11 provided, in its center, with a series of longitudinally spaced guide blocks 12, each having a front face 14, a rear face 16 and opposite side faces 18 and 20.

The series of guide blocks 12 extends in a channel formed between a pair of mid-rollers 22 and 24 forming part of the suspension assembly (not shown) of a convention track propelled vehicle.

The present invention is concerned with providing on each opposite side face of the guide block 12 with a heat resistant thermoplastic or thermosetting member having low friction properties, each side face being exposed to the side surfaces of the track rollers 22 and 24 as well as other rollers (not shown) which may form part of the vehicle suspension assembly riding on the inner side of the lower run of the endless track. The pads 18 and 20 have molding characteristics similar to the rubber material of the track so that a molecular reaction occurs during molding between the low friction material of the pads and the rubber base compound of the track.

Although the invention has been described above with respect to one specific form, it will be evident to a person skilled in the art that it may be modified and refined in various ways. It is therefore wished to have it understood that the present invention should not be limited in scope, except by the terms of the following claims.

1. An endless track for track-propelled vehicles having a track assembly including a drive wheel, an idler wheel and a series of rollers resting on a lower run of the track comprising: a body of elastomeric material having an inner surface and an outer surface; said inner surface displaying thereon a series of longitudinally spaced guide blocks; said guide blocks having a front face, a rear face and opposite side faces; said opposite faces being formed of pads made of low friction resin material.

2. An endless track as defined in claim 1, wherein said pads are integrally molded to said elastomeric material forming said guide blocks.

3. An endless track as defined in claim 1, wherein said resin material is UHMW.
